(19) United States
(12) Patent Application Publication
(10) Pub. No.: US 2014/0287605 A1
(43) Pub. Date: Sep. 25, 2014

(54) SEMICONDUCTOR DEVICE

(71) Applicant: Kabushiki Kaisha Toshiba, Minato-ku (JP)

(72) Inventors: Yuuta YAMADA, Kanagawa-ken (JP); Junichi Asada, Kanagawa-ken (JP)

(73) Assignee: Kabushiki Kaisha Toshiba, MInato-ku (JP)

(21) Appl. No.: 14/142,098

(22) Filed: Dec. 27, 2013

(30) Foreign Application Priority Data
Mar. 25, 2013 (JP) 2013-061740

(51) Int. Cl. H01R 13/44

(52) U.S. Cl. CPC H01R 13/44
USPC 439/135

(57) ABSTRACT

According to one embodiment, a semiconductor device includes a case, a connector, and a cap. The case includes a first main surface, a second main surface opposite to the first main surface, a first concave portion provided with at least one of the first main surface and the second main surface, and a semiconductor memory housed inside. The connector is connected to the case. The cap includes a third main surface, a fourth main surface opposite to the third main surface, a locking portion provided with at least one of the third main surface and the fourth main surface which is locked with the first concave portion, and a side surface provided with an opening portion opening between the third main surface and the fourth main surface.

### CROSS REFERENCE TO RELATED APPLICATION

This application is based upon and claims the benefit of priority from the prior Japanese Patent Application No. 2013-061740, filed on Mar. 25, 2013, the entire contents of which are incorporated herein by reference.

### FIELD

Embodiments described herein relate to a semiconductor device.

### BACKGROUND

There is a semiconductor device that is a connector product composed of a case connected to a USB connector and a detachable cap to protect the USB connector.

### BRIEF DESCRIPTION OF THE DRAWINGS

FIG. 1 is a plan view showing a semiconductor device according to a first embodiment;

FIG. 2 is a plan view showing the semiconductor device according to the first embodiment;

FIG. 3 is a plan view showing the semiconductor device according to the first embodiment;

FIG. 4 is a side view showing the semiconductor device according to the first embodiment;

FIG. 5 is a side view showing the semiconductor device according to the first embodiment;

FIG. 6 is a side view showing the semiconductor device according to the first embodiment;

FIG. 7 is a plan view showing a semiconductor device of a first modification according to the first embodiment;

FIG. 8 is a plan view showing the semiconductor device of the first modification according to the first embodiment;

FIG. 9 is a plan view showing a semiconductor device of a second modification according to the first embodiment;

FIG. 10 is a side view showing the semiconductor device of the second modification according to the first embodiment;

FIG. 11 is a plan view showing a semiconductor device according to a second embodiment;

FIG. 12 is a side view showing the semiconductor device according to the second embodiment;

FIG. 13 is a plan view showing the semiconductor device according to the second embodiment;

FIG. 14 is a side view showing the semiconductor device according to the second embodiment;

FIG. 15 is a plan view showing a semiconductor device of a third modification according to the second embodiment;

FIG. 16 is a plan view showing a semiconductor device of a fourth modification according to the second embodiment;

FIG. 17 is a plan view showing a semiconductor device of a fifth modification according to the second embodiment;

FIG. 18 is a plan view showing a semiconductor device according to a third embodiment; and

FIG. 19 is a plan view showing the semiconductor device according to the third embodiment.

### DETAILED DESCRIPTION

According to one embodiment, a semiconductor device includes a case, a connector, and a cap. The case includes a first main surface, a second main surface opposite to the first main surface, a first concave portion provided with at least one of the first main surface and the second main surface, and a semiconductor memory housed inside. The connector is connected to the case. The cap includes a third main surface, a fourth main surface opposite to the third main surface, a locking portion provided with at least one of the third main surface and the fourth main surface which is locked with the first concave portion, and a side surface provided with an opening portion opening between the third main surface and the fourth main surface.

Hereinafter, a plurality of further embodiments will be described with reference to the drawings. In the drawings, the same symbols indicate the same or similar portions.

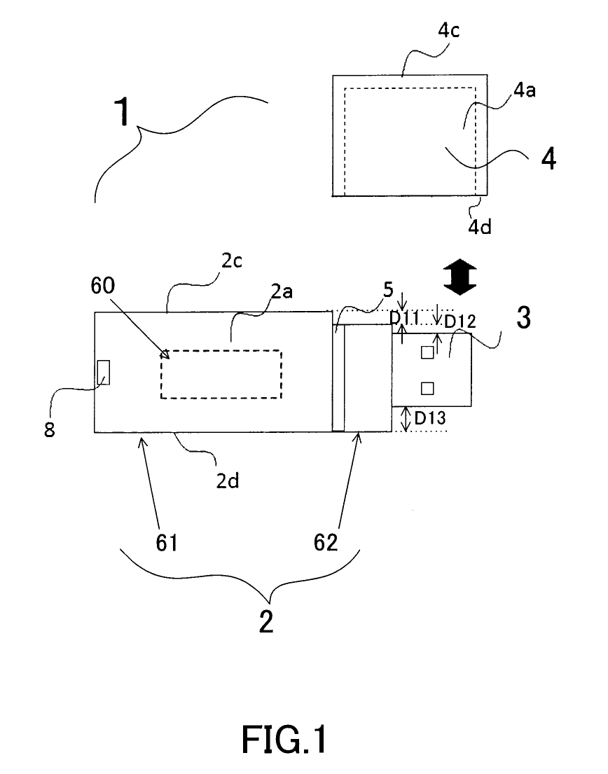

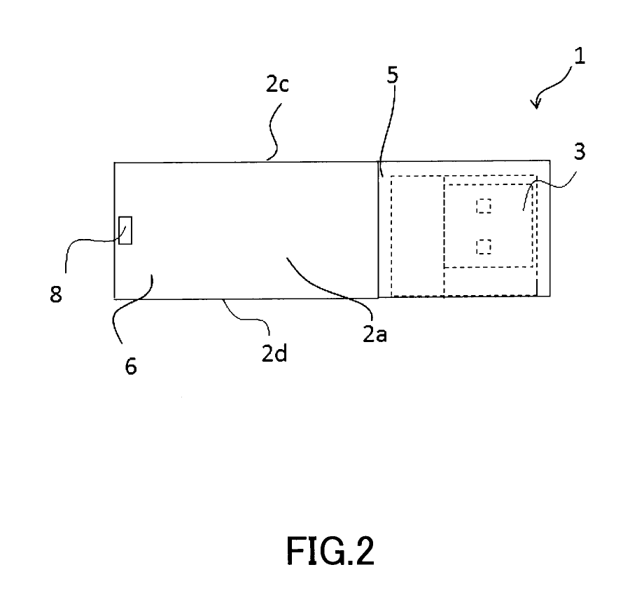

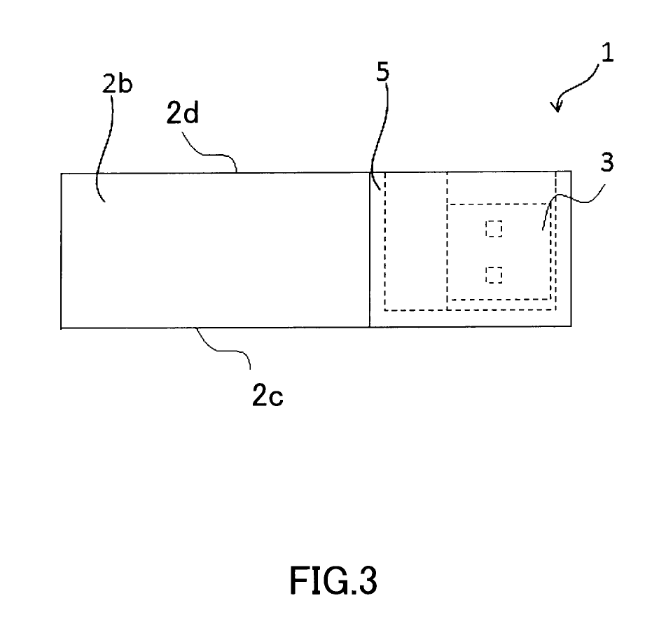

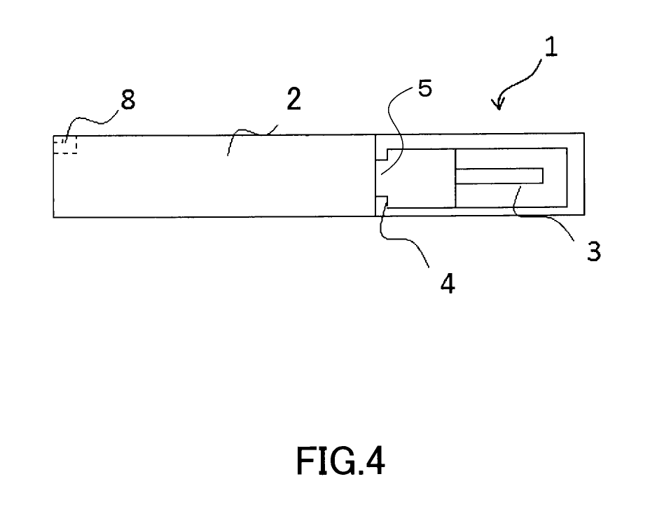

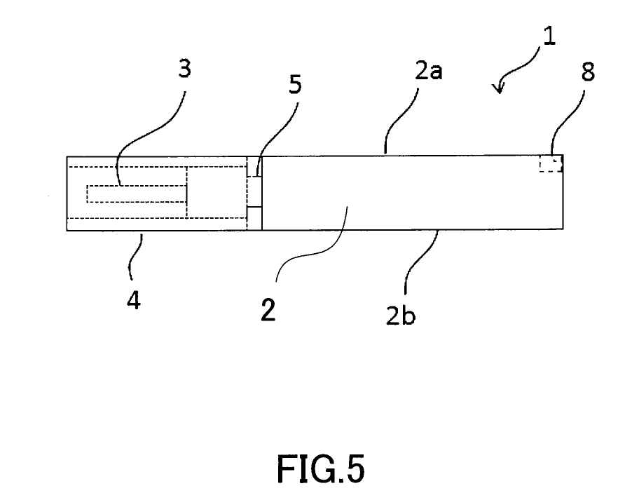

A semiconductor device according to a first embodiment will be described with reference to FIG. 1 to FIG. 6. FIG. 1 to FIG. 6 are views showing a semiconductor device 1 of the first embodiment. FIG. 1 is a plan view of a case 2 and a cap 4 in the state in which they are separated. FIG. 2 and FIG. 3 are plan views of a first main surface 2a and a second main surface 2b in the state in which the cap 4 is mounted on the case 2, respectively. FIG. 4 to FIG. 6 are side views of the semiconductor device 1 of the first embodiment.

As shown in FIG. 1 to FIG. 6, the semiconductor device 1 includes the case 2, a USB connector 3, and the cap 4. The case 2 is composed of a memory housing portion 61 and a cap connecting portion 62. One end of the memory housing portion 61 is connected to one end of the cap connecting portion 62. The memory housing portion 61 houses a semiconductor memory 60 inside. The other end of the cap connecting portion 62 of the case 2 is connected to the USB connector 3 which is electrically connected to the semiconductor memory 60. The memory housing portion 61, the cap connecting portion 62, and the USB connector 3 have a box-type shape in which the size in the horizontal direction is larger than that in the height direction.

The case 2 has the first main surface 2a, the second main surface 2b, a first side surface 2c and a second side surface 2d. The second main surface 2b is a surface opposite to the first main surface 2a. The second side surface 2d is a surface opposite to the first side surface 2c. The case 2 has a strap hole 8 at the other end side of the memory housing portion 61. A strap or a key holder is attached in the strap hole 8, and thereby the semiconductor device 1 can improve the designability.

The cap connecting portion 62 retreats from the memory housing portion 61 at the first side surface 2c by a distance D11. The USB connector 3 retreats from the cap connecting portion 62 at the first side surface 2c by a distance D12, and retreats from the cap connecting portion 62 at the second side surface 2d by a distance D13. Here, in the cap connecting portion 62, the first side surface 2c retreats from the memory housing portion 61 by the distance D11, but the second side surface 2d may retreat from the memory housing portion 61 by the distance D11.

At the one end side of the cap connecting portion 62, a first concave portion 5 which contacts the one end of the memory housing portion 61 is provided. The first concave portions 5 are provided at the first main surface 2a and the second main surface 2b of the case 2 in the width direction (in the longitudinal direction in FIG. 1), respectively. The first concave portion 5 has a long end structure in which the width in the length direction of the case 2 is small, and the width in the width direction of the case 2 is large. The first concave portions 5 of the first main surface 2a and the second main surface 2b are in parallel with each other, and the width and depth of the first concave portions 5 are constant. The first concave portions 5 are provided in the direction perpendicular to the inserting/extracting direction of the terminals of the USB connector 3, for example. It is not necessarily required that the shapes of the first concave portions 5 in the first main surface 2a and the second main surface 2b are the same. In addition, the first concave portion 5 may be provided only at any one of the first main surface 2a, and the second main surface 2b.

Next, the cap 4 will be described. The cap 4 is detachable from the case 2, and functions to protect the USB connector 3 from the external mechanical stress and electrical contact. When the cap 4 is mounted on the case 2, a third main surface 4a and a fourth main surface 4b of the cap 4 are respectively on the same plane as the first main surface 2a and the second main surface 2b of the case 2.

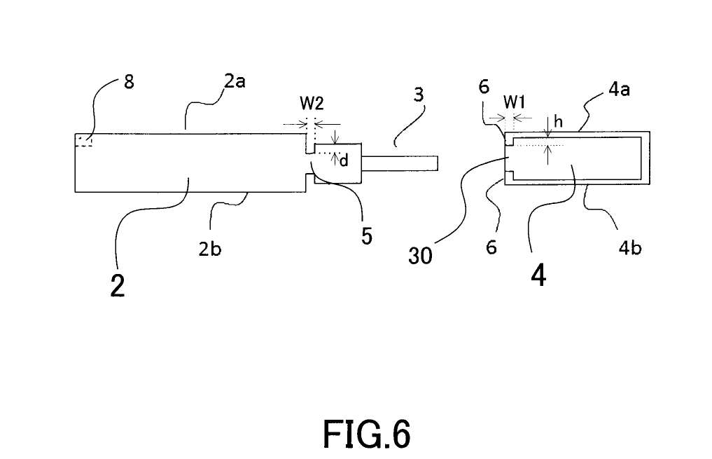

As shown in FIG. 6, locking portions 6 which respectively engage with the first concave portions 5 are provided on the third main surface 4a and the fourth main surface 4b of the cap 4. A width w1 of the locking portion 6 is approximately equal to a width w2 of the first concave portion 5. A height h of the locking portion 6 is approximately equal to a depth d of the portion of the case 2 which engages with the locking portion 6. The locking portions 6 are fitted into the first concave portions 5 of the first main surface 2a and the second main surface 2b of the case 2, to thereby fix the cap 4 to the case 2. The locking portion 6 of the cap 4 may be provided only on any one of the third main surface 4a and the fourth main surface 4b.

As shown in FIG. 4 and FIG. 6, an opening portion 30 which opens between the third main surface 4a and the fourth main surface 4b is provided in the cap 4. On the other hand, the cap 4 at the third side surface 4c is fully closed, and protects the USB connector 3 at the first side surface 2c.

When the cap 4 is mounted on the case 2, it is desirable that the length of the whole cap 4 in the inserting/extracting direction of the USB connector 3 is short in accordance with the length from the first concave portions 5 to the tip portion of the USB connector 3. By this means, the third main surface 4a and the fourth main surface 4b of the cap 4 become difficult to bow. That is, since the width of the opening portion 30 is difficult to widen, the cap 4 is difficult to come off from the case 2.

In FIG. 1 and FIG. 6, when the cap 4 is detached from the case 2, the locking portions 6 are slid along the first concave portions 5 to detach the cap 4.

In addition, though the side surface 4d side of the cap 4 opens, without being limited to the third side surface 4c, the third main surface 4a side may open. The both sides of the third side surface 4c side and the fourth side surface 4d side may open. It is only necessary that the opening portion 30 at the third side surface 4c side of the cap 4 has a width enough to insert the USB connector 3, and the opening 30 may not be completely opened.

The effect of the embodiment is described as below. The locking portions 6 are provided in the cap 4 of the semiconductor device 1 of the embodiment. The attaching and detaching of the cap 4 is performed by sliding the locking portions 6 along on the first concave portions 5. The semiconductor device 1 can reduce the abrasion of the locking portions 6 by friction which is caused by repeatedly performing the attaching and detaching of the cap 4, and thereby it is able to keep the holding power between the cap 4 and case 2 for a long time.

When usually a strap is attached into the strap hole 8, the strap works as a weight, at the time of carrying the semiconductor device 1, and thereby the cap 4 might be pulled out in the inserting/extracting direction of the USB connector 3. On the other hand, since the cap 4 of the embodiment has the structure that the cap 4 does not come off in the inserting/extracting direction of the USB connector 3, it is able to prevent that the cap 4 comes off from the case 2 by the power applied in the inserting/extracting direction of the USB connector 3. Since the locking portions 6 and the first concave portions 5 are provided, the case 2 contacts the cap 4 on a wide surface, and can firmly hold the cap 4. For this reason, in the semiconductor device 1 of the embodiment, it is able to prevent loss of the cap 4, and to protect the USB connector 3 stably for a long time.

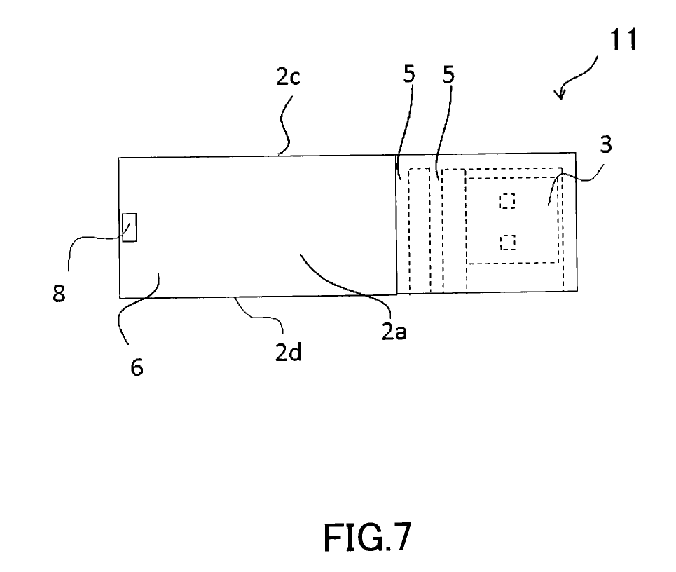

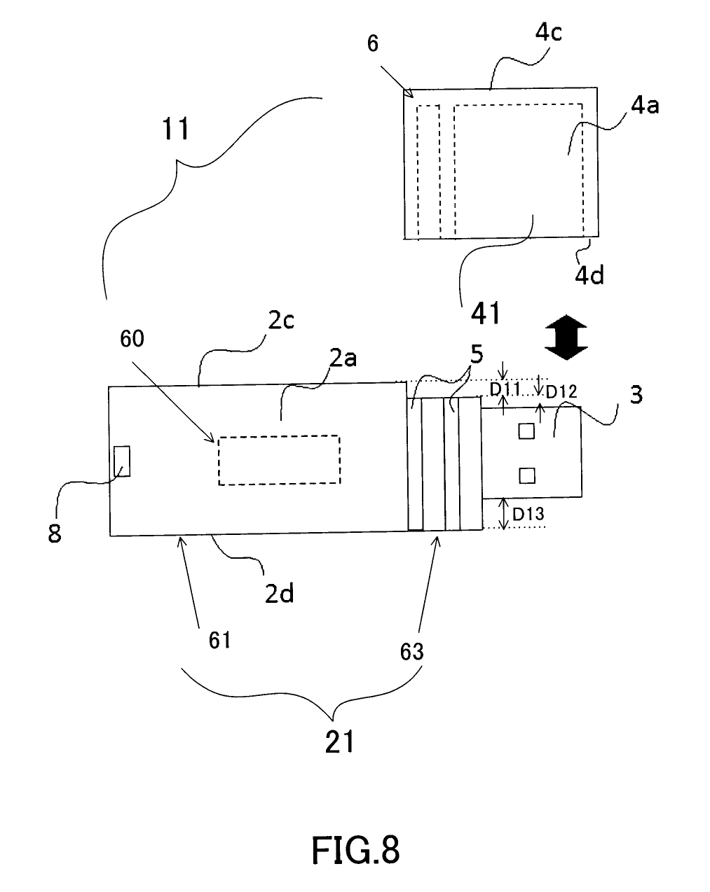

A semiconductor device of a first modification will be described with reference of FIG. 7 and FIG. 8. FIG. 7 and FIG. 8 are plan views of a semiconductor device 11 of the first modification in the first embodiment. As shown in FIG. 7 and FIG. 8, the semiconductor device 11 includes a case 21, the USB connector 3, and a cap 41. The case 21 is composed of the memory housing portion 61 and a cap connecting portion 63. One end of the memory housing portion 61 is connected to one end of the cap connecting portion 63. The memory housing portion 61 houses the semiconductor memory 60 inside. The other end of the cap connecting portion 63 of the case 21 is connected to the USB connector 3 which is electrically connected to the semiconductor memory 60. In the semiconductor device 11 of the first modification, the first concave portions 5 of the cap connecting portion 63 are provided at two positions at the first main surface 2a and the second main surface 2b, respectively. The first concave portions 5 provided on the same plane are in parallel with each other.

In the cap 41, the locking portions 6 are provided by the number corresponding to the number of the first concave portions 5 of the case 21. In the first modification, the first concave portions 5 are increased on the same plane, and the positions into which the locking portions 6 are respectively fitted are increased, and thereby the cap 41 becomes difficult to come off from the case 21. For this reason, the effect to prevent loss of the cap 4 can further be improved.

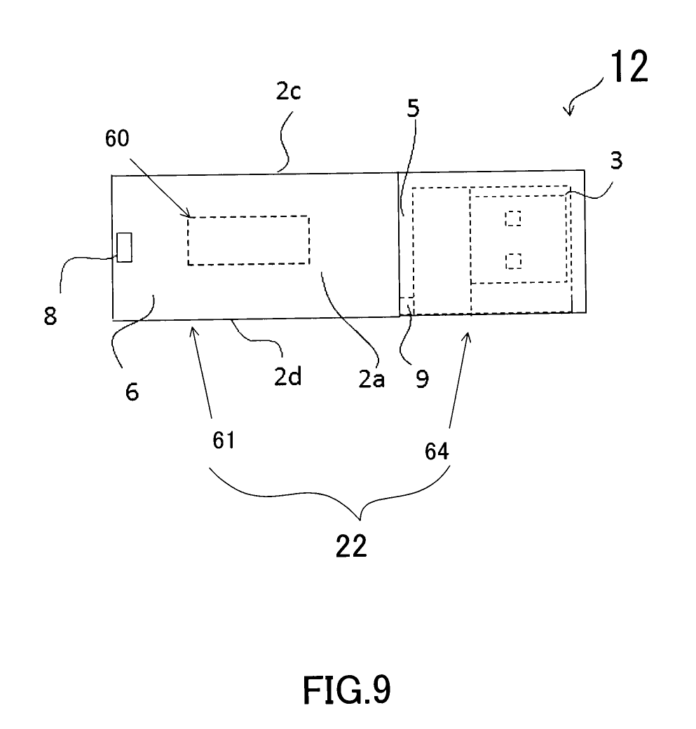

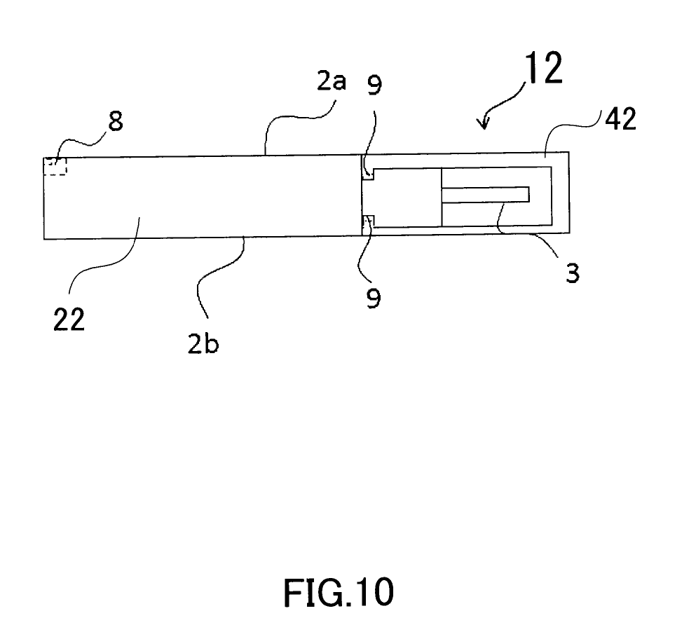

A semiconductor device of a second modification will be described with reference of FIG. 9 and FIG. 10. FIG. 9 is a plan view of a semiconductor device 12 of the second modification in the first embodiment, and FIG. 10 is a side view of the semiconductor device 12 of the modification 2 in the first embodiment. As shown in FIG. 9 and FIG. 10, the semiconductor device 12 of the second modification includes a case 22, the USB connector 3, and a cap 42. The case 22 is composed of the memory housing portion 61 and a cap connecting portion 64. One end of the memory housing portion 61 is connected to one end of the cap connecting portion 64. The memory housing portion 61 houses the semiconductor memory 60 inside. The other end of the cap connecting portion 64 of the case 22 is connected to the USB connector 3 which is electrically connected to the semiconductor memory 60. In the second modification, third concave portions 9 are provided at the ends of the fourth side surface 4d side of the first concave portions 5 of the first main surface 2a and the second main surface 2b. The depth of the third concave portion 9 of the case 22 is deeper than the first concave portion 5.

In the cap 42, the locking portion 6 corresponding to the third concave portion 9 is provided higher compared with the region of the first concave portion 5. When the cap 42 is mounted on the case 22, the cap 42 becomes difficult to come off from the case 22. For this reason, the effect to prevent loss of the cap 42 can be improved. In addition, the third concave portion 9 may be provided only at any one of the first main surface 2a and the second main surface 2b of the case 22.

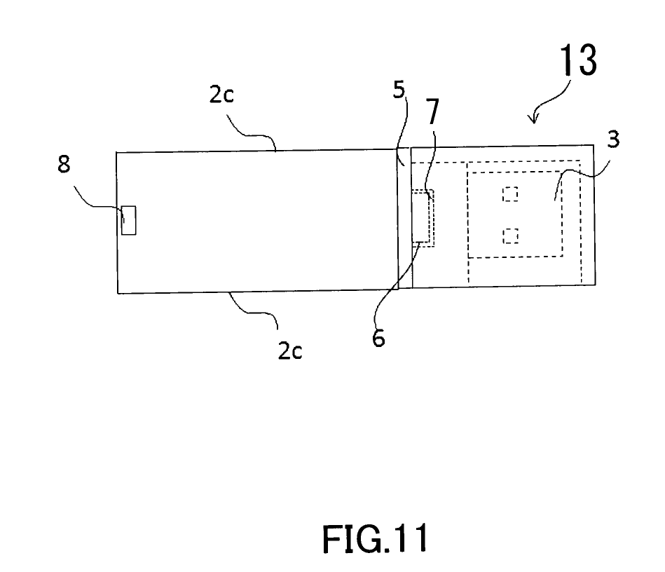

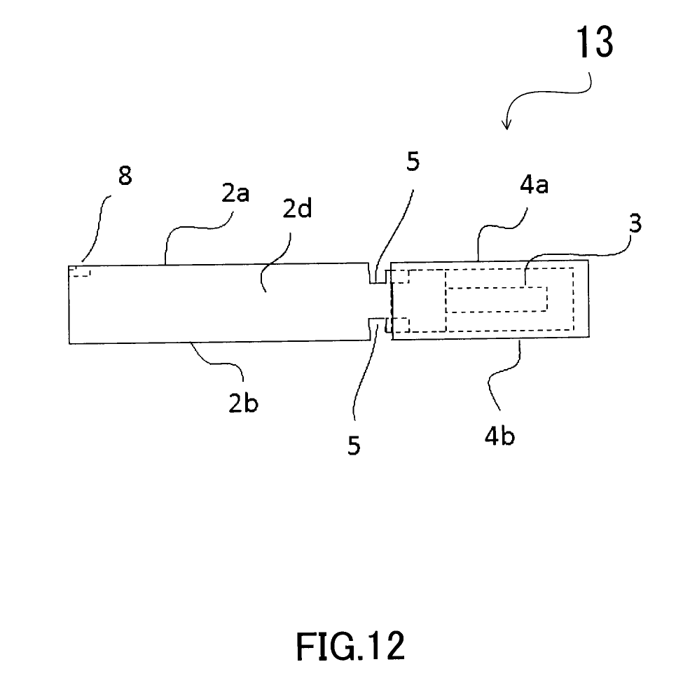

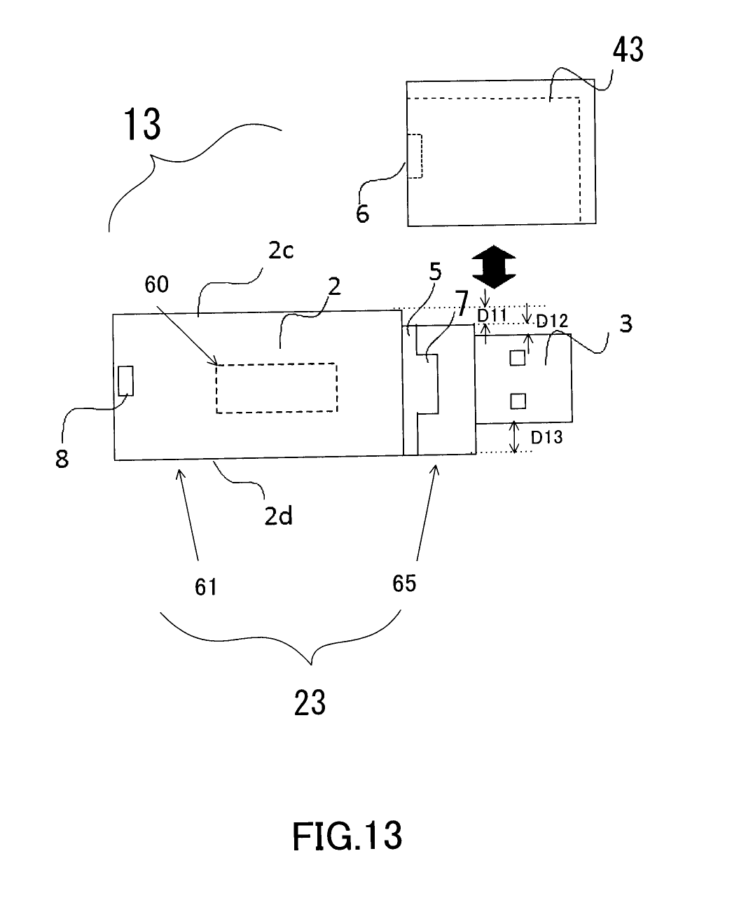

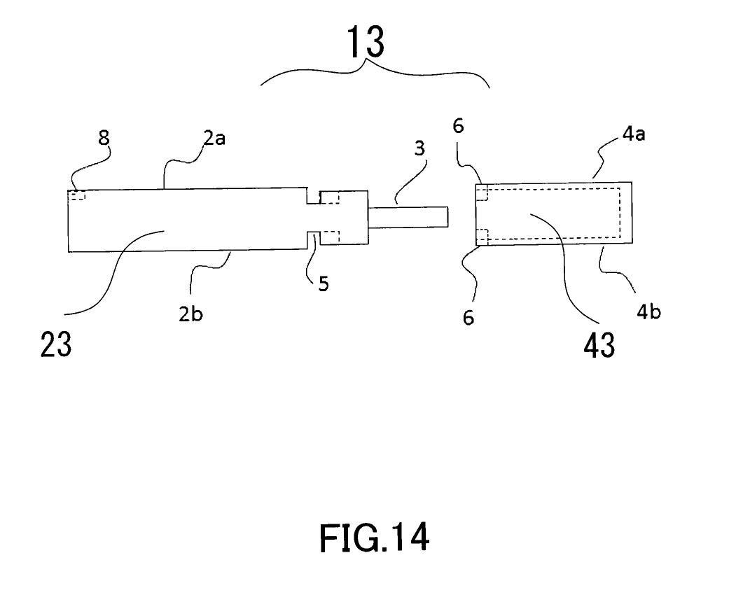

A semiconductor device according to a second embodiment will be described with reference of FIG. 11 to FIG. 14. A semiconductor device 13 of the second embodiment is different from the first embodiment in the point that second concave portions 7 adjacent to the respective first concave portions 5 are provided. FIG. 11 to FIG. 14 are views showing the semiconductor device 13 of the second embodiment.

As shown in FIG. 11 to FIG. 14, the semiconductor device 13 includes a case 23, the USB connector 3, and a cap 43. The case 23 is composed of the memory housing portion 61 and a cap connecting portion 65. One end of the memory housing portion 61 is connected to one end of the cap connecting portion 65. The memory housing portion 61 houses the semiconductor memory 60 inside. The other end of the cap connecting portion 65 of the case 23 is connected to the USB connector 3 which is electrically connected to the semiconductor memory 60. At the second main surface 2b of the cap connecting portion 65 of the case 23, the first concave portion 5 is provided in the same manner as the first main surface 2a. Also, in the cap 43, the locking portion 6 is provided at the fourth main surface 4b in the same manner as the third main surface 4a. The locking portion 6 of the embodiment is provided at a center of a side portion to intercuspate with the second concave portion 7 of the the case 23.

In the cap connecting portion 65 of the case 23, the second concave portions 7 adjacent to the respective first concave portions 5 are provided. The depth of the second concave portion 7 is the same or not less than the depth of the first concave portion 5. The second concave portion 7 is provided at the center of the first concave portion 5, for example. The width of the second concave portion 7 in the inserting/extracting direction of the cap 43 is the same or larger than the width of the locking portion 6 of the cap 43.

When the cap 43 is detached, it is necessary to fit the locking portions 6 into the first concave portions 5 before sliding the locking portions 6 of the cap 43 along the first concave portions 5, respectively. Compared with the case of the first embodiment, when the cap 43 of the semiconductor device 13 of the second embodiment is attached and detached, the second embodiment needs one more process, that is the process to fit the locking portions 6 which are located at the second concave portions 7 into the first concave portions 5, respectively. For this reason, the semiconductor device 13 of the embodiment can improve the effect to prevent loss of the cap 43.

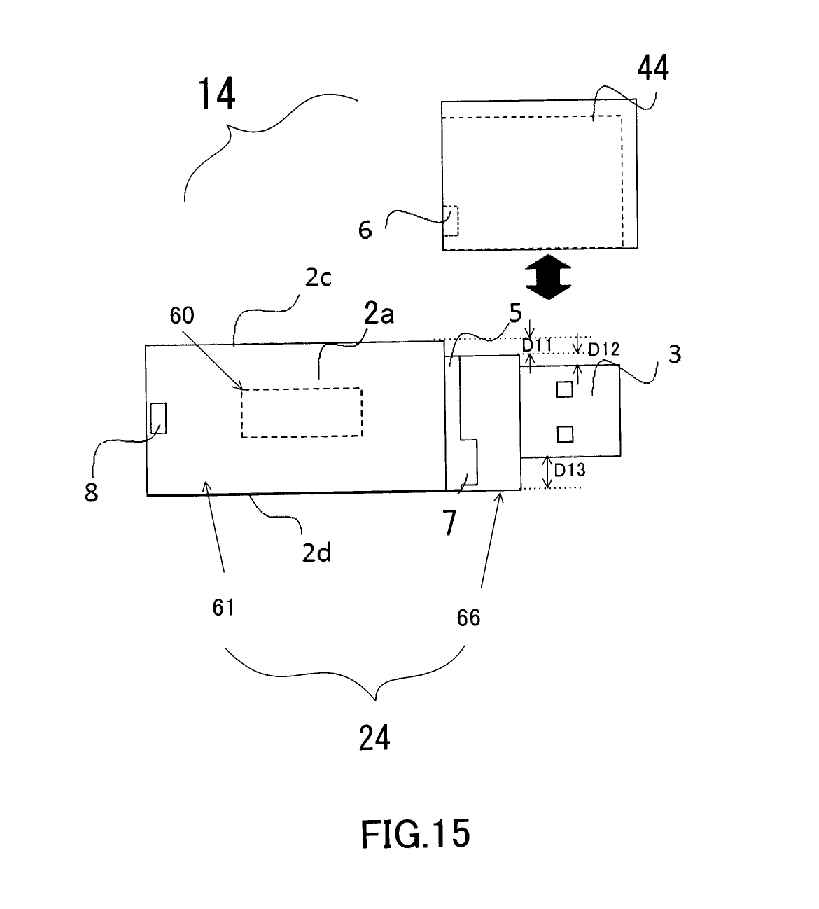

A semiconductor device of a third modification will be described with reference to FIG. 15. FIG. 15 is a plan view of a semiconductor device 14 of the third modification in the second embodiment. As shown in FIG. 15, the semiconductor device 14 of the third modification includes a case 24, the USB connector 3, and a cap 44. The case 24 is composed of the memory housing portion 61 and a cap connecting portion 66. One end of the memory housing portion 61 is connected to one end of the cap connecting portion 66. The memory housing portion 61 houses the semiconductor memory 60 inside. The other end of the cap connecting portion 66 of the case 24 is connected to the USB connector 3 which is electrically connected to the semiconductor memory 60. In the semiconductor device 14, the second concave portions 7 are provided at the first concave portions 5 of the case 24 at the positions which are remotest from the first side surface 2c, respectively. The second concave portions 7 are provided at the first concave portions 5 at the positions which are remotest from the insertion port of the cap 44, respectively. The locking portions 6 of the cap 44 are provided at the positions corresponding to the second concave portions 7, respectively. At the time of the attaching and detaching of the cap 44, the attaching and detaching is performed with the same method as the embodiment.

The second concave portion 7 is located at the USB connector 3 side with the first concave portion 5 as the boundary, but may be provided at the case 24 side. In the third modification, at the time of attaching and detaching, compared with the case in which the second concave portion 7 is located at the center of the first concave portion 5, since the locking portion 6 of the cap 44 is located at the remotest position from the insertion port of the first concave portion 5, at the time of detaching the cap 44, the distance that the locking portion 6 moves on the first concave portion 5 becomes long. For this reason, since the cap 44 become more difficult to come off, the effect to prevent loss of the cap 44 can be improved.

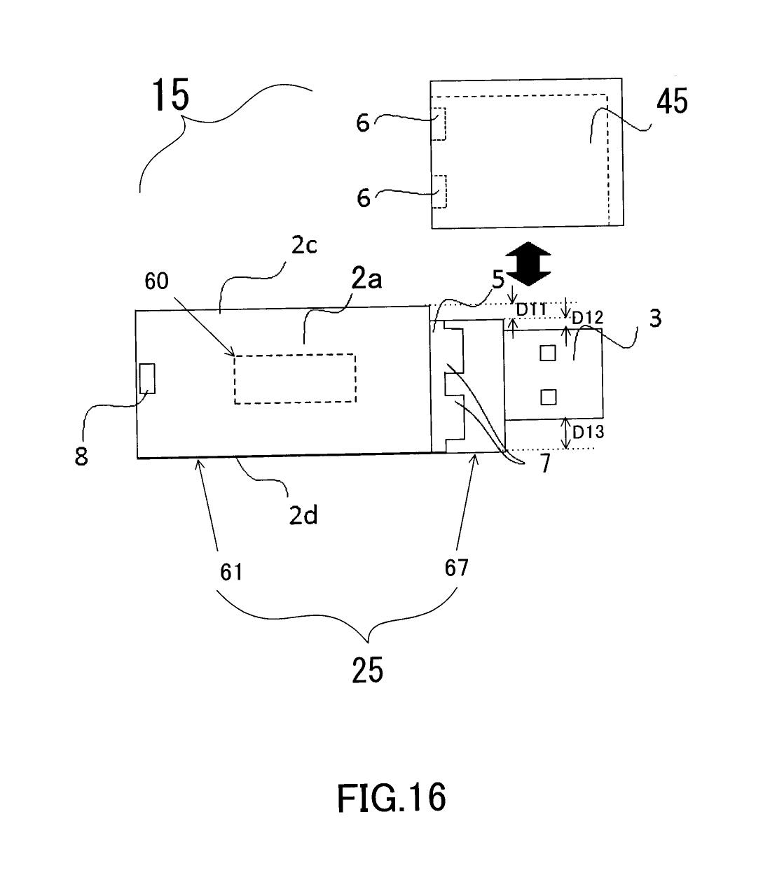

A semiconductor device of a fourth modification will be described with reference to FIG. 16. FIG. 16 is a plan view of a semiconductor device 15 in the fourth modification of the second embodiment. As shown in FIG. 16, the semiconductor device 15 includes a case 25, the USB connector 3, and a cap 45. The case 25 is composed of the memory housing portion 61 and a cap connecting portion 67. One end of the memory housing portion 61 is connected to one end of the cap connecting portion 67. The memory housing portion 61 houses the semiconductor memory 60 inside. The other end of the cap connecting portion 67 of the case 25 is connected to the USB connector 3 which is electrically connected to the semiconductor memory 60. In the cap 45 of the semiconductor device 15, the locking portions 6 are provided at two positions at the third main surface 4a and the fourth main surface 4b, respectively. At the first concave portions 5 of the case 25, the second concave portions 7 are provided at the first main surface 2a and the second main surface 2b at the positions corresponding to the locking portions 6, respectively. The area of the second concave portion 7 is larger than the area occupied by the locking portion 6.

At the time of detaching the cap 45 from the case 25, the locking portions 6 of the first main surface 2a and the second main surface 2b are fitted into the corresponding first concave portions 5, and the locking portions 6 are slid along the first concave portions 5, to thereby perform the detachment.

Without being limited to that the locking portions 6 of the third main surface 4a and the fourth main surface 4b of the cap 45 are provided at two positions, respectively, the locking portions 6 may be provided at three or more positions, respectively.

In the fourth modification, when the cap 45 is detached, the positions where the locking portions 6 are fitted from the second concave portions 7 to the first concave portions 5 are provided at two positions at the third main surface 4a and the fourth main surface 4b, respectively. Compared with the case in which the locking portion 6 and the second concave portion 7 are provided at one position, the more the number of positions where the locking portion 6 is fitted into the first concave portion 5, the more difficult the cap 45 becomes to come off from the case 25. For this reason, the effect to prevent loss of the cap 45 can be improved.

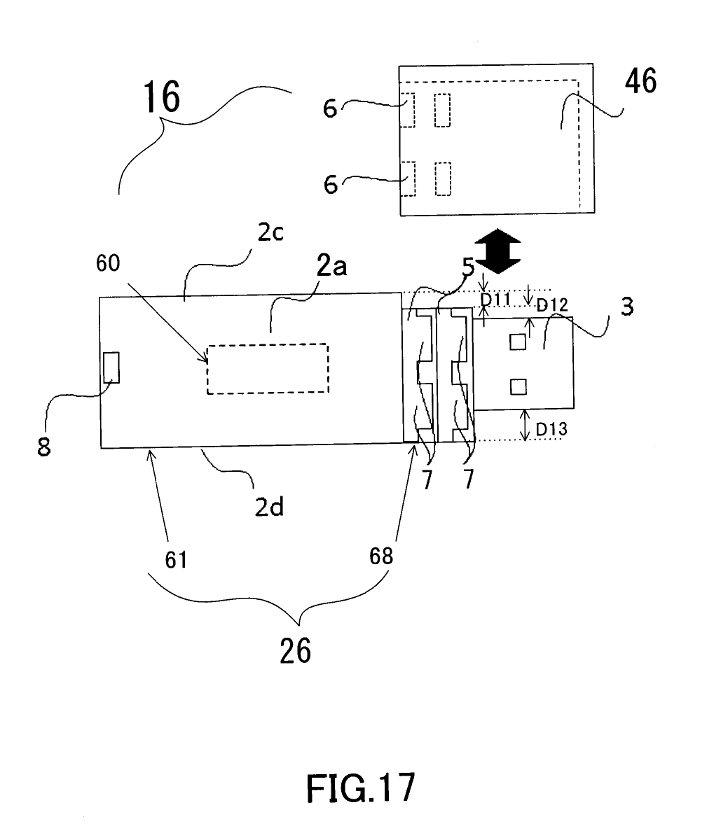

A semiconductor device of a fifth modification will be described with reference to FIG. 17. FIG. 17 is a plan view of a semiconductor device 16 in the fifth modification. As shown in FIG. 17, the semiconductor device 16 includes a case 26, the USB connector 3, and a cap 46. The case 26 is composed of the memory housing portion 61 and a cap connecting portion 68. One end of the memory housing portion 61 is connected to one end of the cap connecting portion 68. The memory housing portion 61 houses the semiconductor memory 60 inside. The other end of the cap connecting portion 68 of the case 26 is connected to the USB connector 3 which is electrically connected to the semiconductor memory 60. In the semiconductor device 16 of the fifth modification, the first concave portions are provided at two positions on the same plane. At each of the first concave portion 5, the second concave portions 7 are provided adjacent to the first concave portion 5.

When the cap 46 is detached from the case 26, it is necessary to fit the whole locking portions 6 into the first concave portions 5, and thereby the effect to make the cap 46 difficult to come off from the case 26 can be improved.

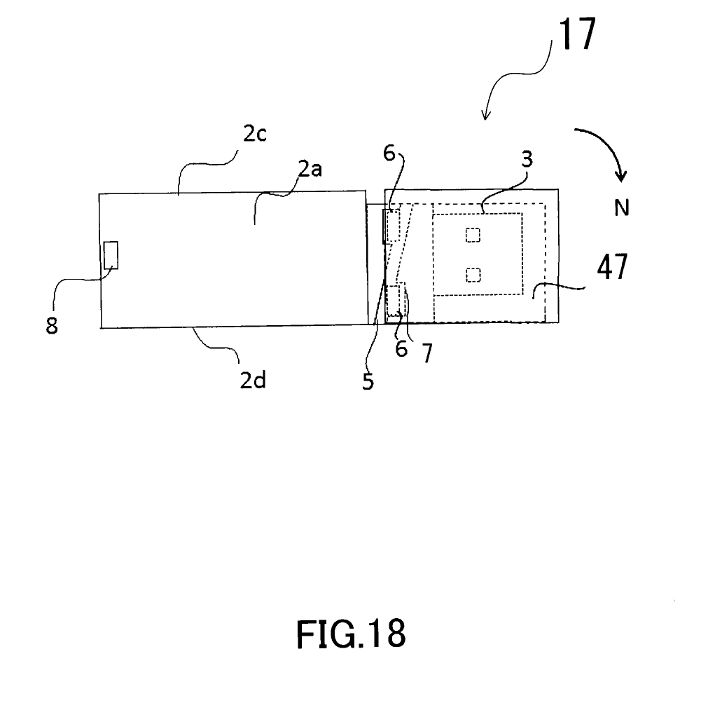

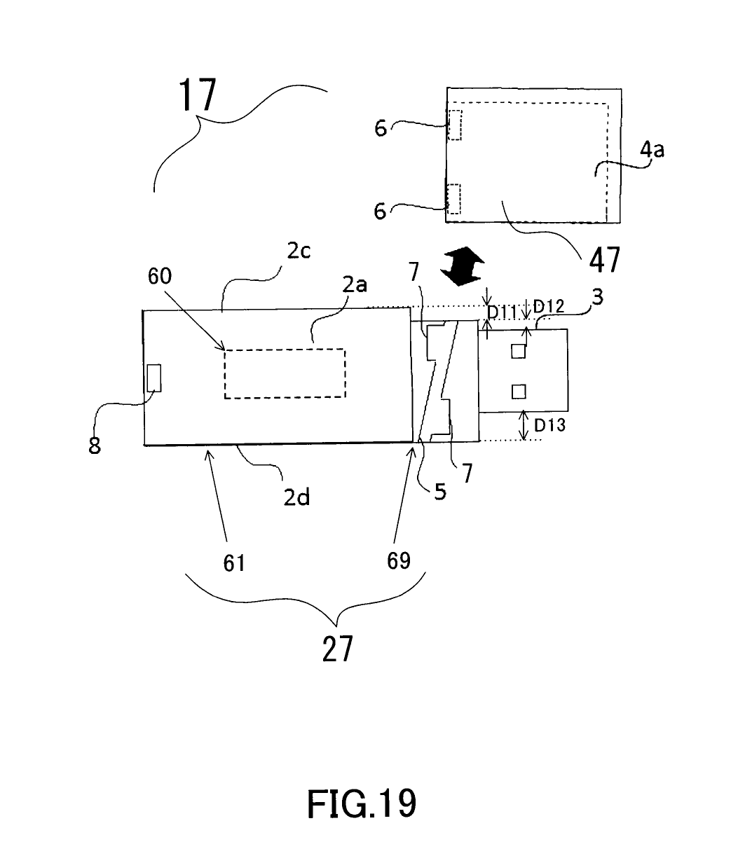

A semiconductor device according to a third embodiment will be described with reference to FIG. 18 and FIG. 19. FIG. 18 and FIG. 19 are views showing a semiconductor device 17 of the third embodiment. As shown in FIG. 18 and FIG. 19, the semiconductor device 17 of the third embodiment includes a case 27, the USB connector 3, and a cap 47. The case 27 is composed of the memory housing portion 61 and a cap connecting portion 69. One end of the memory housing portion 61 is connected to one end of the cap connecting portion 69. The memory housing portion 61 houses the semiconductor memory 60 inside. The other end of the cap connecting portion 69 of the case 27 is connected to the USB connector 3 which is electrically connected to the semiconductor memory 60. The semiconductor device 17 includes the second concave portions 7, and a process to make the cap 47 rotate at the time of detaching the cap 47.

The second concave portions 7 of the case 27 are provided at two positions, for example, and the direction of arrangement of the second concave portions 7 and the opening direction of the first concave portion 5 are not in parallel with each other. The first concave portion 5 and the second concave portions 7 are provided at the first main surface 2a and the second main surface 2b opposite to the first main surface 2a, respectively. In the semiconductor device 17, the second concave portions 7 are provided at the USB connector 3 side near the second side surface 2d, and the strap hole 8 side near the first side surface 2c that is the opposite side, with the first concave portion 5 as the border, respectively.

When the cap 47 is detached from the case 27, the cap 47 is rotated in an N direction, to thereby fit the locking portion 6 into the first concave portion 5. After that, the cap 47 is slid along the concave portions 5, to thereby attach to or detach from the case 27.

In addition, without being limited to that the locking portions 6 are provided at two positions on the same plane, the locking portions 6 may be provided at three of more positions, the locking portion 6 may be provided at a position.

In the semiconductor device 17 of the embodiment, the second concave portions 7 are provided at the USB connector 3 side, and the semiconductor memory 60 side with the first concave portion 5 as the border, respectively, and thereby, at the time of detaching the cap 47 from the case 27, the process to fit the locking portions 6 into the first concave portion 5 by rotating the cap 47 becomes necessary. For this reason, the effect to prevent loss of the cap 47 can be improved.

While certain embodiments have been described, these embodiments have been presented by way of example only, and are not intend to limit the scope of the inventions. Indeed, the novel embodiments described herein may be embodied in a variety of the other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device, comprising:
a case including a first main surface, a second main surface opposite to the first main surface, a first concave portion provided with at least one of the first main surface and the second main surface, and a semiconductor memory housed inside;
a connector connected to the case; and
a cap including a third main surface, a fourth main surface opposite to the third main surface, a locking portion provided with at least one of the third main surface and the fourth main surface which is locked with the first concave portion, and a side surface provided with an opening portion opening between the third main surface and the fourth main surface.

2. The semiconductor device according to claim 1, wherein the case includes a memory housing portion and a cap connecting portion,
the memory housing portion houses the semiconductor memory,
the cap connecting portion includes the first concave portion, the cap connecting portion includes one end connected to one end of the memory housing portion,
the first concave portion contacts one end of the memory housing portion, and
any one of two side surfaces adjacent to the first main surface retreats from the memory housing portion.

3. The semiconductor device according to claim 2, wherein one end of the connector is connected to the other end of the cap connecting portion.

4. The semiconductor device according to claim 2, wherein
a strap hole is provided with the other end side of the memory housing portion.

5. The semiconductor device according to claim 3, wherein
two side surfaces of the connector adjacent to the first main surface retreat from the cap connecting portion.

6. The semiconductor device according to claim 1, wherein
the case includes the first concave portions provided in parallel with each other at two positions.

7. The semiconductor device according to claim 1, wherein
the case includes a second concave portion arranged adjacent to the first concave portion, the second concave portion has a depth equal to a depth of the first concave portion or deeper than the first concave portion,
the locking portion is locked with the first concave portion and the second concave portion.

8. The semiconductor device according to claim 1, wherein
the case includes a third concave portion arranged adjacent to at least one side of the first concave portion in a long end direction, the third concave portion has a depth deeper than the first concave portion.

9. The semiconductor device according to claim 7, wherein
the case includes the second concave portions provided at not less than n positions (here, n is an even number), an opening direction of the first concave portion and a direction of arrangement of the second concave portions are not in parallel with each other, and the second concave portions are provided with one side and the other side of the first concave portion in a long end direction,
the locking portion is locked with the first concave portion and the second concave portion.

10. The semiconductor device according to claim 1, wherein
when the cap is mounted on the case, the third main surface of the cap and the first main surface of the case are on the same plane, and the fourth main surface of the cap and the second main surface of the case are on the same plane.

11. The semiconductor device according to claim 1, wherein
the cap is detachable from the case.

12. The semiconductor device according to claim 9, wherein
when the cap is detached from the case, the cap is rotated to intercuspate the locking portion with the first concave portion, and then the cap is slid.

13. The semiconductor device according to claim 1, wherein
the cap has a structure in which the cap is disable to unjoint in an insertion/extraction direction of the connector.
